(19) United States
(12) Patent Application Publication
(10) Pub. No.: US 2017/0147065 A1
(43) Pub. Date: May 25, 2017

(54) WEARABLE CONTENT NAVIGATION DEVICE

(71) Applicant: TiVo Solutions Inc., San Carlos, CA (US)

(72) Inventor: Richard Lee, San Francisco, CA (US)

(21) Appl. No.: 15/354,902

(22) Filed: Nov. 17, 2016

Related U.S. Application Data
(60) Provisional application No. 62/258,394, filed on Nov. 20, 2015.

(51) Int. Cl. G06F 3/01; G06F 1/16; G06F 3/0346; H04B 1/3827; H04M 1/725

(52) U.S. Cl. CPC G06F 3/011; H04B 1/385; H04M 1/7253; H04M 1/72533; G06F 3/0346; G06F 1/163; H04M 2250/12

(57) ABSTRACT

Techniques, systems, and methods are disclosed to implement a wearable content navigation device configured to interact with one or more media devices through gestures. A mobile device may receive motion data indicating movement of a wearable device. By analyzing the motion data to detect performance of one or more particular gestures, the mobile device may determine, based on a set of mappings between gestures and actions, one or more actions based on the detected one or more particular gestures. Subsequently, performance of the one or more actions by a media device may be caused.

### CROSS-REFERENCE TO RELATED APPLICATIONS; PRIORITY CLAIM

This application claims benefit under 35 U.S.C. §119(e) to U.S. Provisional Application 62/258,394, filed Nov. 20, 2015, the entire contents of each are hereby incorporated by reference for all purposes as if fully set forth herein. The applicant hereby rescinds any disclaimer of claim scope in the parent application(s) or the prosecution history thereof and advise the USPTO that the claims in this application may be broader than any claim in the parent application(s).

### FIELD OF THE DISCLOSURE

The present disclosure relates to the field of wearable computing devices. The disclosure relates more specifically to techniques for using wearable computing devices to interact with media devices via gestures.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Users commonly consume media content at a distance from a media device that plays the content. For example, a user may watch television from the user's couch positioned at a distance from a set-top box or other media device playing the content. In order avoid the inconvenience of operating a media device by pressing input buttons on the media device itself, when at a distance, users commonly use wireless remote control devices to operate such media devices from a distance.

A remote control device typically includes physical input buttons that enable a user to specify operations to be performed by a media device, such as tuning to a particular channel, rewinding or fast-forwarding media content, recording media content, etc. In recent years, smartphones, tablet computers, and other portable computing devices have also been configured for use as remote control devices using touchscreen interfaces generated by software applications, or “apps,” executing on the devices. For example, a remote control app on a smartphone may provide a graphical interface that mimics the button layout of a physical remote control device and which enables a user to provide touch input to cause a media device to perform particular actions.

While traditional remote control devices provide users the ability to operate media devices at a distance, the use of such remote control devices can be cumbersome. For example, users frequently misplace remote control devices and may have difficulty finding a remote control device when needed. In the case of a smartphone remote control app, each time a user desires to use a smartphone remote control app, the user may need to unlock the phone, open a particular application on the phone, and navigate the app interfaces to select the desired remote control functionality. If a user desires to take an urgent action (e.g., pausing content currently playing, or skipping back a certain number of seconds), the user often may have difficulty providing the desired input commands quickly enough using currently existing remote control devices.

### BRIEF DESCRIPTION OF THE DRAWINGS

In the drawings:

FIG. 1 depicts an example networked computer environment in which an embodiment may be implemented;

FIG. 2 depicts example components of a wearable device and a mobile device;

FIG. 3 is a flow diagram of an example process for using wearable computing devices to interact with media devices via gestures;

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

1.0 General Overview

In various embodiments, a mobile device may receive motion data indicating movement of a wearable device. By analyzing the motion data to detect performance of one or more particular gestures using the wearable device, a set of mappings between gestures and actions may be used to determine one or more actions to be performed by a media device. The wearable device may be a smartwatch, in one embodiment.

Motion data indicating movement of the wearable device may also include accelerometer data generated by the wearable device. Additionally, the motion data may further include a series of acceleration measurements, where each acceleration measurement is associated with a timestamp.

The motion data may be analyzed to detect performance of one or more particular gestures includes detecting performance of a particular series of gestures. The performance of particular gestures that are mapped to actions may cause the sending of one or more commands to the media device. Other actions that may be performed at the media device, based on the sending of the one or more commands, include the rewinding, pausing, fast forwarding, and recording multimedia content. Another such action may include the sending of a request to a social networking website. A set of mappings between gestures and actions, in one embodiment, may include at least one customized gesture to action mapping.

2.0 Structural & Functional Overview

2.1 Networked Computer System Example

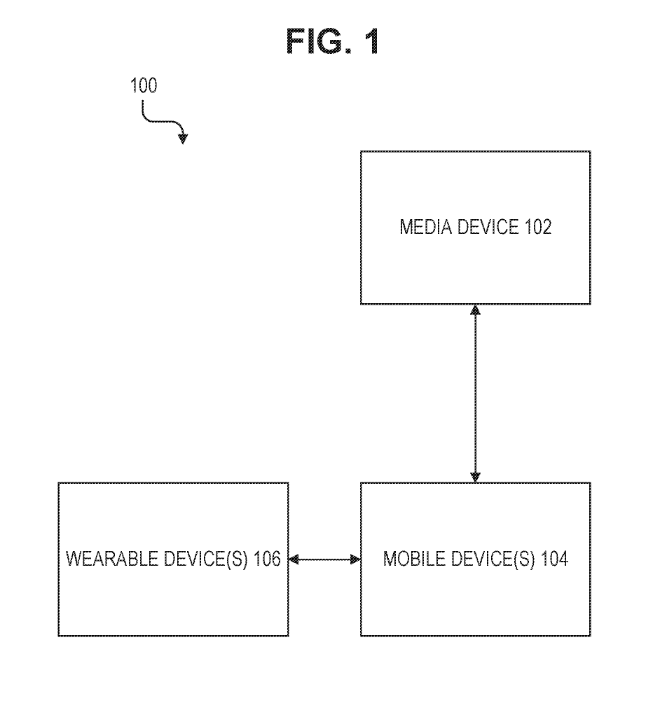

FIG. 1 illustrates a networked computer environment 100 in which an embodiment may be implemented. FIG. 1 represents one example embodiment that is provided for purposes of illustrating a clear example; other embodiments may use different arrangements. Each of the components of FIG. 1 are presented to clarify the functionalities described herein and may not be necessary to implement all embodiments. Furthermore, components not shown in FIG. 1 may also be used to perform the functionalities described herein. Functionalities described as performed by one component may instead be performed by another component.

In an embodiment, a media device 102 is coupled to one or more mobile device(s) 104, and a mobile device 104 is coupled to one or more wearable device(s) 106. Each of a media device 102, a mobile device 104, and a wearable device 106 generally may be coupled to one another and to other devices via one or more LANs, WANs, and/or internetworks using any of wired, wireless, terrestrial, microwave or satellite links, and may include use of the public Internet. In another embodiment, a media device 102 may be connected directly to a wearable device 106 via a wireless connection, such as Wi-Fi, Bluetooth, and the like.

In an embodiment, a media device 102 generally represents any device configured to receive, store, display, or otherwise interact with media content. Examples of a media device 102 include, but are not limited to, any of: a digital video recorder (DVR), a television, a monitor, a desktop computer, a laptop, a tablet computer, a kiosk, a gaming console, etc. A media device 102 may include multiple components, e.g., a display screen, a projector, etc. Media content accessible to a media device 102 generally may include, but is not limited to, television programs, movies, music, video on demand (VOD) content, Internet-based content, etc.

Mobile device(s) 104 of FIG. 1 broadly represent any portable computing devices including, but not limited to, smartphones, tablet computers, other handheld computers, laptop computers, netbook computers, and ultrabook computers. Examples of a mobile device 104 include IPHONE, IPAD or other APPLE IOS devices, ANDROID devices, and MICROSOFT WINDOWS devices.

Wearable device(s) 106 of FIG. 1 broadly represent any type of clothing item, accessory, or other wearable item that incorporates one or more computing or other electronic components. Examples of a wearable device 106 may include watches, glasses, bracelets, earpieces, clothing items, or other items that can incorporate one or more computing components. In an embodiment, a wearable device 106 may include one or more display screen interfaces and physical input buttons (e.g., a watch with a display screen and buttons), or a wearable device 106 may not include any readily accessible user input or output components (e.g., a bracelet with only embedded computing components).

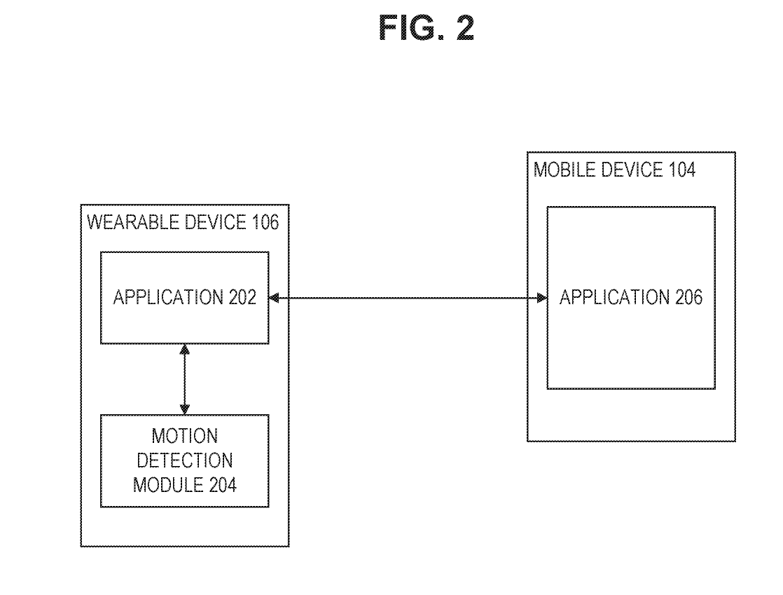

FIG. 2 depicts more detailed components of an example mobile device 104 and wearable device 106. As shown in FIG. 2, each of a mobile device 104 and wearable device 106 may host or execute respective applications or “apps.” In an embodiment, each of application 202 and application 206 may be implemented to execute within a host operating system particular to each of a wearable device 106 and mobile device 104.

In one embodiment, an application 202 of wearable device 106 generally may be configured to facilitate establishing a wireless connection with one or more mobile devices 104, to generate motion data in coordination with a motion detection module 204, to send motion data to one or more mobile devices 104, among other functionality described herein. In an embodiment, application 206 of a mobile device 106 generally may be configured to facilitate establishing connections with one or more wearable devices 106, to receive and analyze motion data from one or more wearable device 106, to cause performance of actions based on gestures detected from the motion data, and other functionality described herein.

A motion detection module 204 of a wearable device 106 generally may be configured to measure movement of a wearable device 106. In one embodiment, motion detection component 110 may include an accelerometer that is capable of measuring acceleration of a wearable device 106 in one or more spatial dimension. For example, acceleration of a wearable device 106 may be caused by a user of the wearable device moving the device in a particular direction or pattern, shaking the device, tapping the device, etc. In an embodiment, motion detection component 110 may also include a gyroscopic sensor or other sensors that provide more detailed information about the movement of a wearable device 106 such as the rotation and/or spatial orientation of a device at a given time.

An application 202 of a wearable device may be configured to create motion data using information received from a motion detection module 204. In one embodiment, motion data may include information that indicates, for each of an x, y, and z spatial axis, an amount of acceleration that the wearable device is experiencing along that axis. The motion data may include a series of such measurements and a timestamp associated with each measurement to indicate movement of the wearable device 106 over time. As described further herein, an application 202 may create and send such motion data to a mobile device 104 for further analysis.

For purposes of illustrating a clear example, FIG. 1 and FIG. 2 show one or a limited number of each element that has been previously described, and practical embodiments or commercial implementations of the techniques herein may use many instances of various elements. For example, in practical implementations there may be multiple mobile devices 104 each communicating with one or more wearable devices 106.

The arrangement of FIG. 1 and FIG. 2 may implement a media content navigation solution that enables users to interact with media content using wearable devices to supplement or replace the use of traditional remote control devices. The embodiments described herein thereby provide a novel media content navigation platform that enables users to efficiently navigate media content using gestures corresponding to various actions.

2.2 Configuring a Gesture-Based Navigation System

As indicated above, a gesture-based media content navigation system may enable users to perform gestures involving movement of a wearable device to cause the occurrence of actions by a media device or other devices. To enable the association of particular gestures with particular actions, the gesture-based media content navigation system may store one or more gesture to action mappings. In an embodiment, a gesture to action mapping generally may include any form of data that associates data representing one or more gestures with data that specifies one or more processing actions to be performed by one or more computing devices.

In one embodiment, an application 206 of a mobile device 104 may store one or more gesture to action mappings, including one or more pre-defined mappings. As one example, a pre-defined gesture to action mapping may indicate that in response to detecting that a user has performed a gesture that includes moving a wearable device 106 vertically upwards, the playing of any currently playing media content by a media device 102 is to be paused. Another example of a pre-defined gesture to action mapping may indicate that in response to detecting that the user has performed a gesture that includes moving a wearable device 106 horizontally to the right, a media device 102 is to fast forward the currently playing content. By providing one or more pre-defined gesture to action mappings, a user may use the gesture-based navigation system by simply learning one or more pre-defined gestures and performing those gestures as desired.

In one embodiment, a gesture-based media content navigation system further may enable a user to create, modify, and/or remove gesture to action mappings from the system. For example, an application 206 of a mobile device 104 may provide one or more graphical user interfaces that enable a user to customize gesture to action mappings. The customization of gesture to action mappings may include the definition of new gestures, the specification of particular actions to be performed by one or more computing devices, and/or the association of one or more defined gestures to one or more of defined actions.

As used herein, a gesture generally refers to any definable type or pattern of motion that may be experienced by a wearable device 106 during use. As one example, a gesture may correspond to movement of a wearable device in a particular direction (e.g., vertically up, or horizontally to the right). As another example, a gesture may correspond to a pattern of motion corresponding to a user moving a wearable device in a circular motion, back and forth in a particular direction, or with a particular amount of force in a direction. Other examples of possible gestures include, but are not limited to, shaking a wearable device, tapping the device, rotating the device, holding the device stationary for a period of time, etc.

In an embodiment, the creation and/or modification of a gesture to action mapping may include training an application 206 of a mobile device 104 to recognize performance of particular gestures. For example, in order to register a new gesture with the system, one or more graphical user interfaces generated by application 206 of a mobile device 104 may prompt a user to perform a desired gesture one or more times using a wearable device 106. The user may then perform a particular gesture using the wearable device 106 (e.g., by moving the wearable device in a particular pattern) causing application 206 to receive motion data from the wearable device 106 that corresponds to the performed gesture. Based on the received motion data and using various gesture recognition training techniques, application 206 may store a data representation of the performed gesture that enables the application 206 to detect future occurrences of the same gesture.

The creation and/or modification of gesture to action mappings may include specification of one or more actions. In one embodiment, one or more actions may correspond to commands that a mobile device 104 may send to a media device 102 to cause the media device to perform one or more operations. For example, one command may specify to a media device 102 a video playing speed and direction of any currently playing media content. Examples of other commands that may be sent to a media device include, but are not limited to, pausing the playing of media content, resuming the playing of media content, replaying a portion of media content, stopping playing of media content, stopping playing of media content and resuming playing of the media content at a particular playing position, playing the media content in slow motion, frame-stepping through video content, playing media content from the beginning, playing one or more media content items from a next playlist, playing video content from a particular scene forward, bookmarking a playing position in media content, stopping playing of the media content and resuming playing at a bookmarked position, changing the volume, rating the media content, and sending media content to another device.

In an embodiment, a command may select a particular option out of a list of options. For example, a list of available media content may be displayed on a screen and the command may select particular media content of the available media content. In another example, a list of configuration settings may be displayed and the command may select a particular setting for modification.

In an embodiment, a command may cause mobile device 104 and/or media device 102 to send a request to one or more external services accessible via the Internet. For example, a command may cause a mobile device 104 and/or media device 102 to send a request to a content provider site or social networking site indicating that the user likes a currently playing media content item, that the user desires to purchase a currently playing media content, that the user desires to find additional content similar to the currently playing media content, etc.

2.3 Performing Gesture-Based Navigation Commands

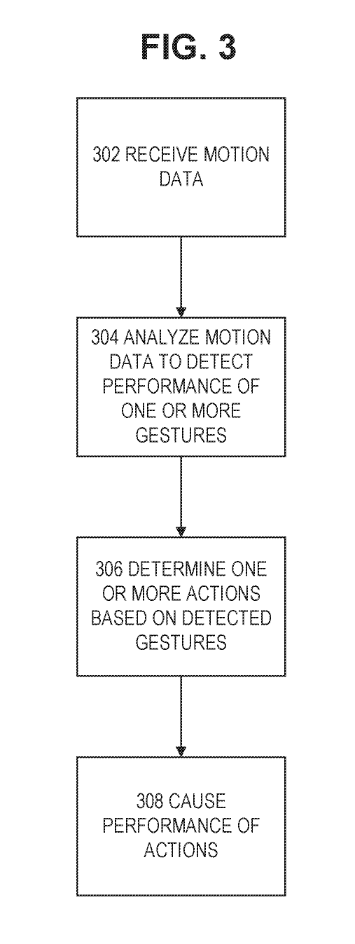

FIG. 3 is a flow diagram illustrating an example process for navigating media content and performing other actions using a wearable device via gestures. The example process illustrated in FIG. 3 may be implemented, for example, using one or more computer programs, scripts, or other software elements that are hosted on or executed by a media device 102, a mobile device 104, and/or a wearable device 106.

For the purposes of illustrating a clear example in relation to FIG. 3, assume that a user is wearing a wearable device 106 and that the wearable device 106 has established a wireless network connection with a mobile device 104. As one example, the user may be in the user's living room wearing a smartwatch that has established a wireless network connection with the user's smartphone. The user's smartwatch and smartphone may be connected via a Bluetooth®, Wi-Fi, or any other type of wireless network connection. The user's smartphone further may be coupled to one or more media devices (e.g., a DVR in the user's living room) and possibly to other devices via one or more local or Internet-based network connections.

Block 302 of FIG. 3 comprises a mobile device receiving motion data describing movement of a wearable device. For example, an application 202 of a wearable device 106 may send the motion data to an application 206 of a mobile device 104. The wearable device 106 may send the motion data to mobile device 104 in response to the wearable device 106 detecting an amount of movement of the wearable device 106, as part of a continuous stream of motion data sent from the wearable device 106 to the mobile device 104, in response to a request from mobile device 104, or at any other time.

As indicated above, motion data generated by a wearable device 106 may include information describing movement of the wearable device 106 in one or more spatial dimensions over time. For example, the motion data may include a series of g-force measurements relative to each of an x, y, and z axis, where each measurement in the series of measurements is associated with a timestamp indicating a time when the measurement was generated. Application 206 may store the received data for subsequent analysis, and may optionally perform one or more operations to transform the data into a format more suitable for analysis.

Block 304 comprises analyzing the received motion data to detect performance of one or more gestures. In one embodiment, an application 206 of a mobile device 104 may analyze the motion data received from a wearable device 106 to detect whether a user has performed one or more particular gestures. In other embodiments, application 202 of wearable device 106 and/or other devices may perform some or all of the data analysis to detect the performance of one or more particular gestures.

As described above, a gesture generally refers to any defined pattern or type of motion that may be exhibited by a wearable device 106. For example, if the wearable device 106 is a smartwatch worn on a user's wrist, detectable gestures may include the user raising the smartwatch vertically, shaking the smartwatch, moving the smartwatch in a patterned shape, etc. Performance of such gestures may cause the wearable device 106 to generate motion data that corresponds to the user's movement and which enables a mobile device 104 to distinguish the gestures from other movement of the device. For example, because a user wearing a wearable device 106 may frequently cause a wearable device to move in ways that are not intended as gestures, analyzing received motion data to detect gestures generally may include analyzing the data to distinguish purposeful gesture movements from other incidental movement of the device.

In an embodiment, analyzing the motion data to detect performance of gestures may include analyzing accelerometer data. As described above, accelerometer data may provide information about acceleration of the wearable device along one or more of three spatial axes and may further include timestamps or other information to indicate movement of the device over time. By analyzing the data indicating along which axes a wearable device has experienced acceleration at particular points in time, an application 206 of a mobile device 104 may be able to determine an approximation of how the wearable device has moved.

In one embodiment, analyzing accelerometer data may include determining an approximate spatial orientation of the device relative to gravity. For example, an accelerometer of a wearable device 106 may provide information about acceleration of the device along spatial axes relative to the device's enclosure, but may not directly provide information about the orientation of the device relative to gravity. Because the spatial orientation of a wearable device relative to gravity may not be immediately apparent from accelerometer data, it may be difficult to determine a particular direction (e.g., up, down, left, or right) in which the device is moving during performance of a gesture. In one embodiment, a spatial orientation of a wearable device relative to gravity may be approximated by observing that the device experiences a constant amount of acceleration downwards due to gravity. By factoring the acceleration due to gravity into the analysis of the accelerometer data, an approximate orientation of the device relative to the gravity may be determined and included in the gesture analysis.

In an embodiment, detecting performance of a gesture may include matching an analysis of motion data against one or more stored gesture data descriptions. As described above, a mobile device 104 may store one or more gesture to action mappings that each include a data representation of one or more gesture movements. Thus, detecting the performance of a particular gesture may include determining whether an analysis of the motion data received from a wearable device matches, within a similarity threshold, any of the data representations of gesture movements stored in the one or more gesture mappings.

Detecting performance of a gesture may include detecting the performance of a series of gestures. For example, a gesture-based navigation system may be configured such that a user performs a particular first gesture to indicate that the user desires to perform a command gesture, followed by a second gesture that corresponds to a desired command. The detection of the first gesture may help prevent the unintentional performance of command gestures.

Block 306 comprises determining one or more actions based on a detected gesture. For example, an application 206 of a mobile device 104 may locate one or more stored gesture to action mappings that match the detected gesture, as described above. The matching gesture to action mappings may specify one or more actions to be performed by application 206 of mobile device 104. In one embodiment, a mobile device 104 may request confirmation from the user before performing a particular action to ensure that the user intended to perform the determined action.

Block 308 comprises causing performance of the one or more actions determined for the detected gesture. In an embodiment, causing performance of the one or more actions may include a mobile device 104 performing one or more actions and/or sending one or more commands to one or more other devices including a media device 102. As described above, commands sent to a media device 102 may cause the media device 102 to perform one or more actions relative to media items available to the media device 102 or otherwise affecting operation of the media device 102.

In one embodiment, a command sent to a media device 102 may cause the media device to send media content or information associated with media content to another device. For example, one command may cause a media device 102 to stream media content to a mobile device 104 and/or a wearable device 106 for display. As another example, one command may cause a media device 102 to send auxiliary information associated with media content to another device such as a title of a show, list of actors, other airing times, etc. This may enable a user to quickly obtain additional information about a currently playing media content item by performing a gesture.

2.3 Wearable Device Alerts

As described herein, a gesture-based content navigation system generally may enable users wearing a wearable device to perform gestures to cause performance of one or more actions by a media device and/or other devices. According to an embodiment, a wearable device further may be configured to receive alerts and other information from a mobile device and/or media device.

In one embodiment, a wearable device 106 may be configured to receive and display alerts indicating information such as the availability of a media content item, an operational status of a media device, or promotional information. For example, a mobile device 104 and/or media device 102 may be configured to send an alert to a user's wearable device 106 in response to detecting that a particular show of interest to the user is currently airing, that a recording the user scheduled at the media device 102 has completed, to promote an upcoming program, or based on the occurrence of other events. A wearable device 106 may present an alert to a user by displaying information associated with the alert on a display screen of the wearable device 106, by causing activation of a light or other visual cue on the device, by causing the device to vibrate, and/or using any other alert mechanism.

3. Implementation Example—Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

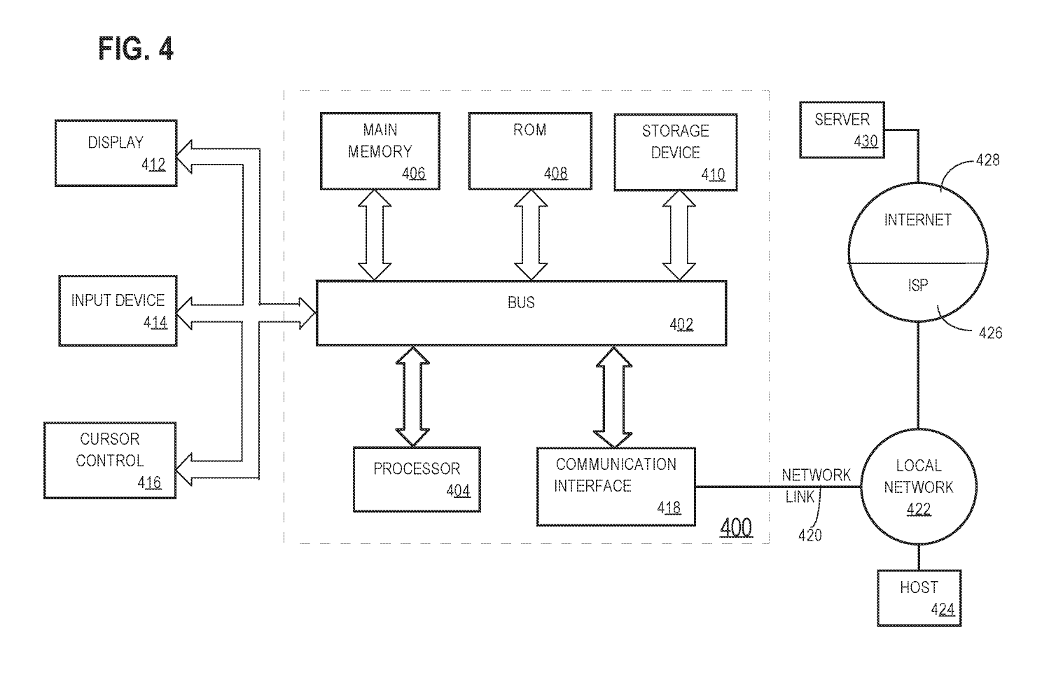

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

4. Interpretation of Terms

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

In the appended claims, any clause, element or limitation of a claim that does not include the words “means for” is not intended to invoke or to be construed under 35 U.S.C. §112(f). In the appended claims, any clause, element or limitation that is expressed as a thing for performing or configured to perform a specified function without the recital of structure, material or acts in support thereof is intended to be construed to cover the corresponding structure, material or acts described in the specification, and any other structure, material or acts that were known or in use as of the priority date to which this patent document is entitled or reasonably foreseeable to those of ordinary skill in the art in view of the disclosure as a whole herein, and equivalents thereof.

What is claimed is:

1. A method comprising:
receiving, by a mobile device, motion data indicating movement of a wearable device;
analyzing the motion data to detect performance of one or more particular gestures;
determining, based on a set of mappings between gestures and actions to be performed, one or more actions based on the detected one or more particular gestures;
sending, by the mobile device, the determined one or more actions to a media device;
causing performance of the determined one or more actions by the media device.

2. The method of claim 1, wherein the wearable device is a smartwatch.

3. The method of claim 1, wherein the motion data indicating movement of the wearable device includes accelerometer data generated by the wearable device.

4. The method of claim 1, wherein the motion data includes a series of acceleration measurements, each acceleration measurement associated with a timestamp.

5. The method of claim 1, wherein analyzing the motion data to detect performance of one or more particular gestures includes detecting performance of a particular series of gestures.

6. The method of claim 1, wherein causing performance of the one or more actions by the media device includes sending one or more additional commands to another media device.

7. The method of claim 1, wherein the one or more actions includes one or more of rewinding, pausing, fast forwarding, and recording multimedia content.

8. The method of claim 1, wherein the action includes sending a request to a social networking website.

9. The method of claim 1, wherein the set of mappings between gestures and actions include at least one customized gesture to action mapping.

10. A non-transitory computer-readable medium storing instructions, wherein the instructions, when executed by one or more processors, cause the one or more processors to perform:
receiving, by a mobile device, motion data indicating movement of a wearable device;
analyzing the motion data to detect performance of one or more particular gestures;
determining, based on a set of mappings between gestures and actions to be performed, one or more actions based on the detected one or more particular gestures;
sending, by the mobile device, the determined one or more actions to a media device;
causing performance of the determined one or more actions by the media device.

11. The non-transitory computer-readable medium of claim 10, wherein the wearable device is a smartwatch.

12. The non-transitory computer-readable medium of claim 10, wherein the motion data indicating movement of the wearable device includes accelerometer data generated by the wearable device.

13. The non-transitory computer-readable medium of claim 10, wherein the motion data includes a series of acceleration measurements, each acceleration measurement associated with a timestamp.

14. The non-transitory computer-readable medium of claim 10, wherein analyzing the motion data to detect performance of one or more particular gestures includes detecting performance of a particular series of gestures.

15. The non-transitory computer-readable medium of claim 10, wherein causing performance of the one or more actions by the media device includes sending one or more additional commands to another media device.

16. The non-transitory computer-readable medium of claim 10, wherein the one or more actions includes one or more of rewinding, pausing, fast forwarding, and recording multimedia content.

17. The non-transitory computer-readable medium of claim 10, wherein the action includes sending a request to a social networking website.

18. The non-transitory computer-readable medium of claim 10, wherein the set of mappings between gestures and actions include at least one customized gesture to action mapping.

19. An apparatus comprising:
a subsystem, implemented at least partially in hardware, that receives, by a mobile device, motion data indicating movement of a wearable device;
a subsystem, implemented at least partially in hardware, that analyzes the motion data to detect performance of one or more particular gestures;
a subsystem, implemented at least partially in hardware, that determines, based on a set of mappings between gestures and actions to be performed, one or more actions based on the detected one or more particular gestures;
a subsystem, implemented at least partially in hardware, that sends, by the mobile device, the determined one or more actions to a media device;
a subsystem, implemented at least partially in hardware, that causes performance of the determined one or more actions by the media device.

20. The apparatus of claim 19, wherein the wearable device is a smartwatch.

21. The apparatus of claim 19, wherein the motion data indicating movement of the wearable device includes accelerometer data generated by the wearable device.

22. The apparatus of claim 19, wherein the motion data includes a series of acceleration measurements, each acceleration measurement associated with a timestamp.

23. The apparatus of claim 19, wherein analyzing the motion data to detect performance of one or more particular gestures includes detecting performance of a particular series of gestures.

24. The apparatus of claim 19, wherein causing performance of the one or more actions by the media device includes sending one or more additional commands to another media device.

25. The apparatus of claim 19, wherein the one or more actions includes one or more of rewinding, pausing, fast forwarding, and recording multimedia content.

26. The apparatus of claim 19, wherein the action includes sending a request to a social networking website.

27. The apparatus of claim 19, wherein the set of mappings between gestures and actions include at least one customized gesture to action mapping.
